(19) United States
(12) Patent Application Publication
(10) Pub. No.: US 2026/0118221 A1
(43) Pub. Date: Apr. 30, 2026

(54) Device and method for processing a digital signal

(71) Applicant: Aktiebolaget SKF, Goteborg (SE)

(72) Inventor: Allan Alexander Thomson, Guisborough (GB)

(73) Assignee: Aktiebolaget SKF, Goteborg (SE)

(21) Appl. No.: 19/359,797

(22) Filed: Oct. 16, 2025

(30) Foreign Application Priority Data
Oct. 30, 2024 (DE) 102024210459.0

(51) Int. Cl. G01M 13/045

(52) U.S. Cl. CPC G01M 13/045

(57) ABSTRACT

A device for processing a continuous signal sampled at a fixed sample rate to obtain a digital signal. The continuous signal includes condition monitoring data of a rotating element. The rotating element undergoes rotational speed changes. The device includes a segmenting means (15), a spectral analysis means (16), a filtering means (17), a first processing means (18), a memory (19), a second processing means (20), and a sampling means (21).

### CROSS-REFERENCE TO RELATED APPLICATION

This application claims priority to German Patent Application No. 102024210459.0, filed Oct. 30, 2024, the entirety of which is hereby incorporated by reference.

### FIELD

The present disclosure is directed to devices for processing a digital signal and methods for processing a digital signal.

### BACKGROUND

Condition monitoring algorithms, for example to detect a fault of a bearing such as a fault of an inner raceway of the bearing, require a constant rotational speed of the bearing to work properly.

Generally, condition monitoring algorithms perform spectral analysis of the rotating bearing to detect faults from specific tones and harmonics.

Rotational speed changes of the bearing during signal measurement smears out the spectral tones reducing the ability to identify the frequencies and harmonics that may be associated with faults, for example faults of an inner raceway of the bearing or faults of the outer raceway of the bearing.

Without access to tachometer or other direct speed measurement devices, the difficulties to correct for speed variations may be further exacerbated by complex speed variation profiles such as profiles containing several accelerations, deceleration phases, as well as time-varying tone amplitude change.

Consequently, the present disclosure intends to correct deleterious effects of rotational speed changes.

### SUMMARY

According to an aspect, a method for processing a continuous signal sampled at a fixed sample rate to obtain a digital signal, the continuous signal comprising condition monitoring data of a rotating element, the rotating element undergoing rotational speed changes.

The method comprises:
(a) segmenting the timestamped samples of the digital signal into a plurality of frames,
(b) transforming each frame of the plurality of frames into the frequency domain and providing arrays comprising absolute values of magnitude and frequency of each transformed frame,
(c) for each transformed frame, determining significant spectral peaks from background noise and their peak center frequencies,
for each pair of frames of a set of frames of the plurality of frames:
(d) determining all feasible frequency ratios of each significant spectral peak of a first frame of the said pair with respect to each significant spectral peak of a second frame of the said pair,
(e) clustering the frequency ratios into clusters of similar frequency ratios,
(f) determining the cluster having the greatest number of frequency ratios and a speed change coefficient from the frequency ratios of the cluster having the greatest number of frequency ratios,
(g) assigning a timestamp value to the speed change coefficient determined at step (f), the timestamp value to the speed change coefficient being determined according to at least one timestamp value of the first or second frame of the said pair,
(h) storing the speed change coefficients and their timestamp values in an array,
(i) generating a speed profile from speed change coefficients and their timestamp values stored in the array, and
(j) resampling the digital signal in the radian domain according to the speed profile.

The method allows machine-health assessment for systems and/or sensors which have no means for direct rotational speed measurement.

The method allows to use of any existing algorithm that has been designed for constant speed conditions and are industrially accepted, trusted and well-understood.

The method further obviates repetitive attempts at data acquisition that only must be discarded due to speed changes.

Instead, such data may now be used effectively. The suppression of repetitive attempts at data acquisition permit to save supply power of a system implementing the method, for example a wireless system comprising a supply source such as a battery.

Advantageously, step (i) comprises:
for each timestamp value, selecting a representative speed change coefficient of the speed change coefficients stored in the array,
multiplying each representative speed change coefficient with the average speed of the rotating element to obtain speed values,
obtaining arrays of the representative speed change coefficients depending on their timestamp values, and
applying an interpolation to the selected speed change coefficients to obtain the speed profile.

Preferably, selecting the representative speed change coefficient for each timestamp value comprises:
clustering the speed change coefficients associated to the said timestamp value, and
applying a statistical method to cluster to determine the representative speed change coefficient.

Advantageously, the method comprises applying a Hanning window to each frame of the plurality of frames prior transforming each frame of the plurality of frames into the frequency domain.

Preferably, the method comprises zero padding each frame of the plurality of frames prior transforming each frame of the plurality of frames into the frequency domain.

Advantageously, step (d) further comprises cancelling each frequency ratio which is not included in a predetermined interval comprising feasible frequency ratios.

According to another aspect, a device for processing a continuous signal sampled at a fixed sample rate to obtain a digital signal, the continuous signal comprising condition monitoring data of a rotating element, the rotating element undergoing rotational speed changes, is proposed.

The device comprises:
segmenting means configured to segment the timestamped samples of the digital signal into a plurality of frames,
spectral analysis means configured to transform each frame of the plurality of frames into the frequency domain and providing arrays comprising absolute values of magnitude and frequency of each transformed frame,
filtering means configured to determine significant spectral peaks from background noise and their peak center frequencies for each transformed frame,
first processing means configured for each pair of frames of a set of frames of the plurality of frames, to:
   determine all feasible frequency ratios of each significant spectral peak of a first frame of the said pair with respect to each significant spectral peak of a second frame of the said pair,
   cluster the frequency ratios into clusters of similar frequency ratios,
   determine the cluster having the greatest number of frequency ratios and a speed change coefficient from the frequency ratios of the cluster having the greatest number of frequency ratios,
   assign a timestamp value to the speed change coefficient determined at step (f), the timestamp value to the speed change coefficient being determined according to at least one timestamp value of the first or second frame of the said pair,
a memory configured to store the speed change coefficients and their timestamp values in an array,
second processing means configured to generate a speed profile from speed change coefficients and their timestamp values stored in the array, and
sampling means configured to resample the digital signal in the radian domain according to the speed profile.

Preferably, the first processing means are further configured to apply a Hanning window to each frame of the plurality of frames prior transforming each frame of the plurality of frames into the frequency domain.

Advantageously, the first processing means are further configured to zero pad each frame of the plurality of frames prior transforming each frame of the plurality of frames into the frequency domain.

According to an aspect, a bearing device is proposed.

The bearing device comprises:
a bearing provided with an inner ring and with an outer ring capable of rotating concentrically relative to one another,
a sensor configured to measure the vibrations of the said inner or outer ring and configured to deliver a continuous signal
a sampler configured to sample the continuous signal at a fixed sample rate and configured to deliver the digital signal comprising the sequential samples, and
a device as defined above configured to process the digital signal.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a machine according to the present disclosure,

FIG. 2 illustrates schematically an example of a device for processing a digital signal according to the present disclosure,

FIG. 3 illustrates schematically a method for processing a digital signal according to the present disclosure,

FIG. 4 illustrates schematically an example of clusters of speed change coefficients according to the present disclosure,

FIG. 5 illustrates schematically an example of the speed profile according to the present disclosure, and

FIG. 6 illustrates schematically examples of spectrum delivered by spectral analysis means for a bearing undergoing rotational speed changes during measurement according to the prior art and according to the present disclosure.

### DETAILED DESCRIPTION

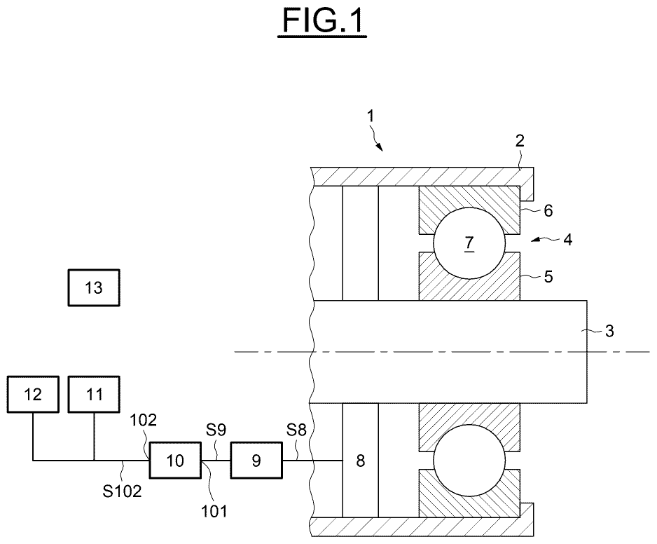

Reference is made to FIG. 1 which represents schematically a partial longitudinal cross section of a machine 1.

The machine 1 comprises a housing 2 and a shaft 3 supported in the housing 2 by a rolling bearing 4 (e.g. roller bearing or ball bearing).

The rolling bearing 4 is provided with an inner ring 5 mounted on the shaft 3, and with an outer ring 6 mounted into the bore of the housing 2. The outer ring 6 radially surrounds the inner ring 5. The inner and outer rings 5, 6 rotate concentrically relative to one another.

The rolling bearing 4 is further provided with a row of rolling elements 7 radially interposed between inner and outer raceways of the inner and outer rings 5, 6. In the illustrated example, the rolling elements 7 are balls. Alternatively, the rolling bearing may comprise other types of rolling elements 7, for example rollers. In the illustrated example, the rolling bearing comprise one row of rolling elements 7. Alternatively, the rolling bearing comprise may comprise several rows of rolling elements.

A sensor 8 is mounted in the housing 2 to measure vibrations of the bearing 4 undergoing rotational speed changes.

The sensor 8 may be mounted on a bore of the housing 2.

In variant, the sensor 8 may be mounted elsewhere on the machine, near the outer ring 6 or in the vicinity of housing 2, for example.

The sensor 8 delivers a continuous signal S8 representative of the operation of a rotating element.

The rotating element may be the bearing 4 and the sensor 8 delivers the continuous signal S8 representative of the vibration of the bearing 4 to an input of a sampler 9.

The sampler 9 delivers a digital signal S9 comprising timestamped samples xₚ of the continuous signal S8 sampled at a fixed sample rate to an input 101 of a device 10 for processing the digital signal S9, p being an integer.

The bearing 4, the sensor 8, the sampler 9 and the device 10 form a bearing device.

A memory (not represented) may store the output signal S9 and delivers the output signal S9 to the device 10.

An output 102 of the device 10 may be connected to implementing means 11 implementing at least one constant speed time domain algorithm from a first output signal S102 delivered by the device 10 on the first output 102, for example to implement an enveloping fault detection algorithm.

The output 102 of the device 10 may be further connected to second implementing means 12 to perform a spectral analysis of the output of the device 10.

The second implementing means 12 implement for example a fast Fourier transform.

The first and second implementing means 11, 12 are for example each made of a processing unit implementing the said algorithm.

A processing unit 13 implements the sensor 8, the sampler 9, and the device 10.

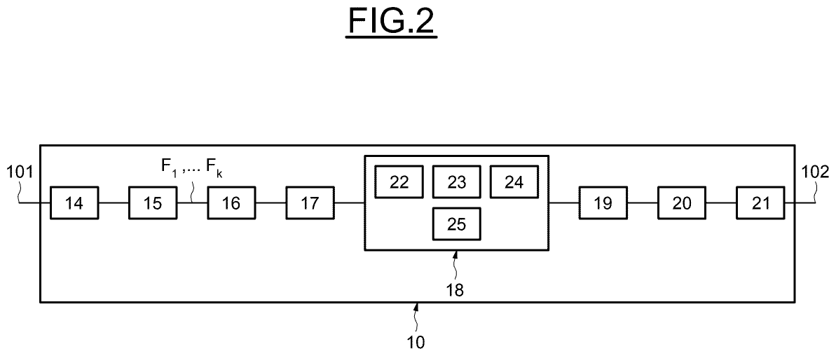

FIG. 2 illustrates schematically an example of the device 10.

The device 10 comprises a first memory 14, segmenting means 15, spectral analysis means 16, filtering means 17, first processing means 18, a second memory 19, second processing means 20 and sampling means 21.

The first memory 14 is intended to store the digital signal S9 comprising the timestamped samples xₚ received on the input 101 of the device 10.

The first memory 14 is connected to an input of the segmenting means 15.

The segmenting means 15 further comprise a first output connected to an input of the spectral analysis means 16.

The segmenting means 15 are intended to segment the sequential samples xₚ of the digital signal into a plurality of frames F₁, F₂ . . . Fₖ₋₁, Fₖ, k being an integer. The frames have an identical size.

The segmenting means 15 may be further intended to zero pad the frames F₁, F₂ . . . Fₖ₋₁, Fₖ and to apply a Hanning window to each frame F₁, F₂ . . . Fₖ₋₁, Fₖ of the plurality of frames.

The sequential samples xₚ are grouped together in the p frames.

The integer p is determined according to the resolution expected to capture speed changes of the machine in each frame.

The segmenting means 15 are intended to deliver the frames F₁, F₂ . . . Fₖ₋₁, Fₖ on the input of the of the spectral analysis means 16.

An output of the spectral analysis means 16 is connected to an input of the filtering means 17.

The spectral analysis means 16 are intended to perform a spectral analysis of the frames F₁, F₂ . . . Fₖ₋₁, Fₖ to provide arrays comprising absolute values of frequencies and magnitudes of each frame F₁, F₂ . . . Fₖ₋₁, Fₖ.

The zero padding of the frames F₁, F₂ . . . Fₖ₋₁, Fₖ and/or applying the Hanning window improve the spectral resolution.

The spectral analysis means 16 implement for example a fast Fourier transform algorithm.

An output of the filtering means 17 is connected to inputs of the first processing means 18.

The filtering means 17 are intended to determine significant spectral peaks from background noise and their peak center frequencies of the transform frames F₁, F₂ . . . Fₖ₋₁, Fₖ from the arrays comprising absolute values of frequencies and magnitudes of the frames F₁, F₂ . . . Fₖ₋₁, Fₖ.

The filtering means 17 implement for example a noise carpet filter to filter noise of the frequency spectrum of the frames F₁, F₂ . . . Fₖ₋₁, Fₖ to keep only those components which may be for example +10 dB above the local spectral carpet level. The significant spectral peaks are components which may be +10 dB above the local spectral carpet level.

The first processing means 18 comprises a memory 22 intended to store arrays comprising peak center frequencies of each significant spectral peak of the frames F₁, F₂ . . . Fₖ₋₁, Fₖ along the number of frames.

The first processing means 18 further comprises first determination means 23, clustering means 24 and assigning means 25.

An output of the first processing means 18 is connected to a second memory 19.

An input of the second processing means 20 is connected to the second memory 19 and an output of the second processing means 20 is connected to an input of the sampling means 21.

An output of the sampling means 21 is connected to the output 102 of the device 10.

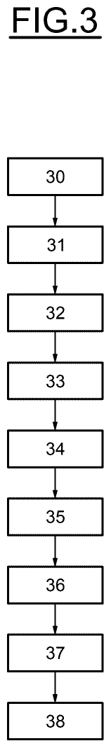

FIG. 3 illustrates an example of a method for processing the digital signal S9 implementing the device 10.

In a step 30, the sampler 9 delivers the digital signal S9 comprising the timestamped samples xₚ from the continuous signal S8 delivered by the sensor 8.

The timestamped samples xₚ are stored in the memory 14.

In a step 31, the segmenting means 15 determine the frames F₁, F₂, . . . , Fₖ₋₁, Fₖ.

In a step 32, the spectral analysis means 16 transform each frame of the plurality of frames F₁, F₂, . . . , Fₖ₋₁, Fₖ into the frequency domain and provide the arrays comprising absolute values frequencies and magnitudes and of each transformed frame.

In a step 33, the filtering means 17 determine the significant spectral peaks and their peak center frequencies of the transform frames F₁, F₂ . . . Fₖ₋₁, Fₖ from the arrays comprising absolute values of frequencies and magnitudes of the frames F₁, F₂ . . . Fₖ₋₁, Fₖ, and deliver arrays comprising peak center frequencies of each significant spectral peak of the frames F₁, F₂ . . . Fₖ₋₁, Fₖ along the number of frames.

The arrays delivered by the filtering means 17 are stored in the memory 22 of the first processing means 18.

In a step 34, a set of frames of the plurality of frames F₁, F₂ . . . Fₖ₋₁, Fₖ is defined.

The set may comprise a part of the plurality of frames F₁, F₂ . . . Fₖ₋₁, Fₖ or all the frames of the plurality of frames F₁, F₂ . . . Fₖ₋₁, Fₖ.

In a step 35, pairs of frames of the set of frames are determined.

Each pair of frames comprise a first frame Fᵢ and a second frame Fⱼ, i, j being different integers.

For each pair of frames Fᵢ, Fⱼ, in a step 36, the first determination means 23 determine all feasible frequency ratios of each significant spectral peak of the first frame Fᵢ of the said pair with respect to each significant spectral peak of the second frame Fⱼ of the said pair.

The frequency ratios represent speed variations (accelerations and decelerations) of the rotating element between the first and the second frames Fᵢ, Fⱼ.

Some frequency ratios may be representative of speed variations are unrealistic.

The first determination means 23 cancel each frequency ratio which is not included in a predetermined interval comprising feasible frequency ratios.

The clustering means 24 cluster the frequency ratios into clusters of similar frequency ratios.

Each cluster has the same width centred on a different frequency value.

The clustering means 24 determine the cluster having the greatest number of frequency ratios.

The clustering means 24 further determine a speed change coefficient from the frequency ratios of the cluster having the greatest number of frequency ratios.

The speed change coefficient is determined using various static methods, for example mean frequency of the cluster having the greatest number of frequency ratios, physical center, centroid, weighted mean frequency ratio.

The assigning means 25 assign a timestamp value to the speed change coefficient.

The assigned timestamp value is determined according to at least one timestamp value of the first or second frame Fᵢ, Fⱼ of the said pair.

The assigned timestamp value is for example equal to the mid-point timestamp of the second frame Fⱼ.

The speed change coefficients and their timestamp values of the pairs of frames of the set of frames are stored in an array stored in the second memory 19.

In a step 37, the second processing means 20 generate a speed profile from speed change coefficients and their timestamp values stored in the array.

For each timestamp value, a representative speed change coefficient of the speed change coefficients stored in the array is selected.

The second processing means 20 may select a first speed change coefficient β1 stored in the array which represents speed variations between the first frame F₁ and the second frame F₂, a second speed change coefficient β2 stored in the array which represents speed variations between the second frame F₂ and the third frame F₃ . . . , a k−1 speed change coefficient βk−1 stored in the array which represents speed variations between the k−1 frame Fₖ₋₁ and the k frame Fₖ. Two consecutive frames comprising sequential samples xₚ.

The representative speed change coefficients are the speed change coefficient β1 . . . βk−1.

In another embodiment, the second processing means 20 may determine and select the speed change coefficients which may represent speed variations between two non-consecutive frames so that for example a speed change coefficient β1,3 stored in the array which represents speed variations between the first frame F₁ and the third frame F₃, a speed change coefficient β1,3 stored in the array which represents speed variations between the first frame F₁ and the third frame F₃ . . . , a change coefficient β2,k stored in the array which represents speed variations between the frame F₂ and the frame Fₖ.

In another embodiment, the second processing means 20 determine a matrix of speed change coefficients comparing all frames in turn against all the other frames is stored in the second memory 19.

A plurality of speed change coefficients are associated to each timestamp value.

The second processing means 20 cluster the speed change coefficients associated to each timestamp value.

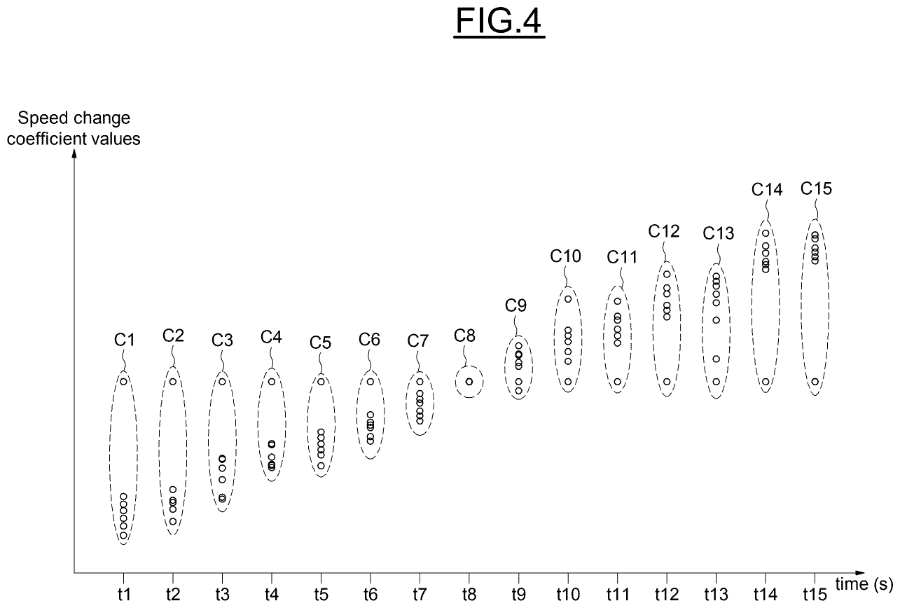

FIG. 4 illustrates an example of clusters of speed change coefficients.

Each dot represents a speed change coefficient of the matrix.

The speed change coefficients associated to the instant t1 are clustered in a cluster C1, similarly the speed change coefficients associated to the instant tn are clustered in a cluster Cn, n being for example between 2 and 15.

Of course, the speed change coefficients may be clustered in more than fifteen clusters or less than fifteen clusters.

For each cluster C1 to C15 (timestamp value), the representative speed change coefficient is determined by various statistical methods, such as the mean value of the speed change coefficient values of each cluster, curve fitting of the speed change coefficient values of each cluster or other statistical methods.

When the the representative speed change coefficients are determined, the second processing means 20 multiply each representative speed change coefficient with the average speed of the rotating element to obtain speed values.

The second processing means 20 determine arrays of the representative speed change coefficients depending on their timestamp values and apply an interpolation to the selected speed change coefficients to obtain the speed profile. The interpolation may be for example linear or polynomial or spline depending on the density of the representative speed change coefficients.

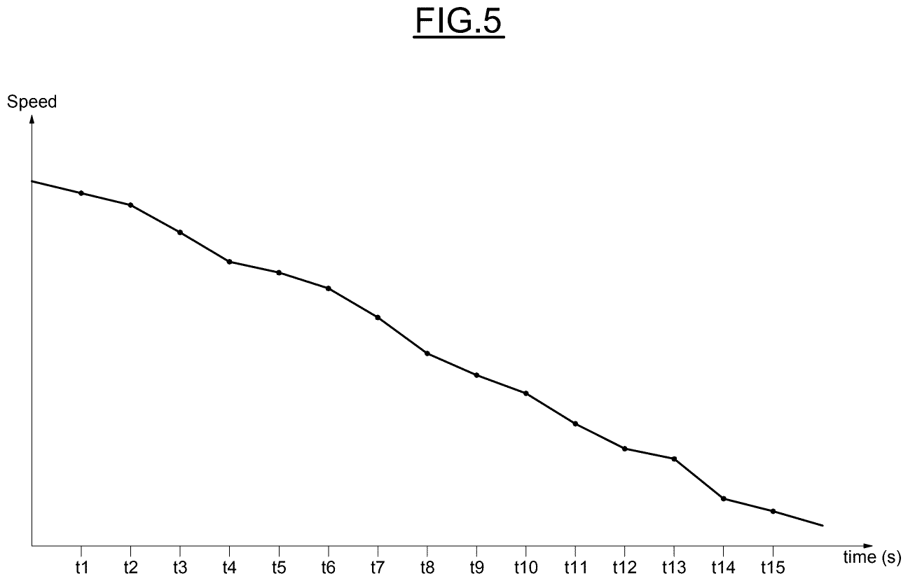

FIG. 5 illustrates an example of the speed profile.

The dots represent the representative speed change coefficients associated to the timestamp values t1 to t15.

In a step 38, the sampling means 21 resample the digital signal S9 in the radian domain according to the speed profile determined in step 37.

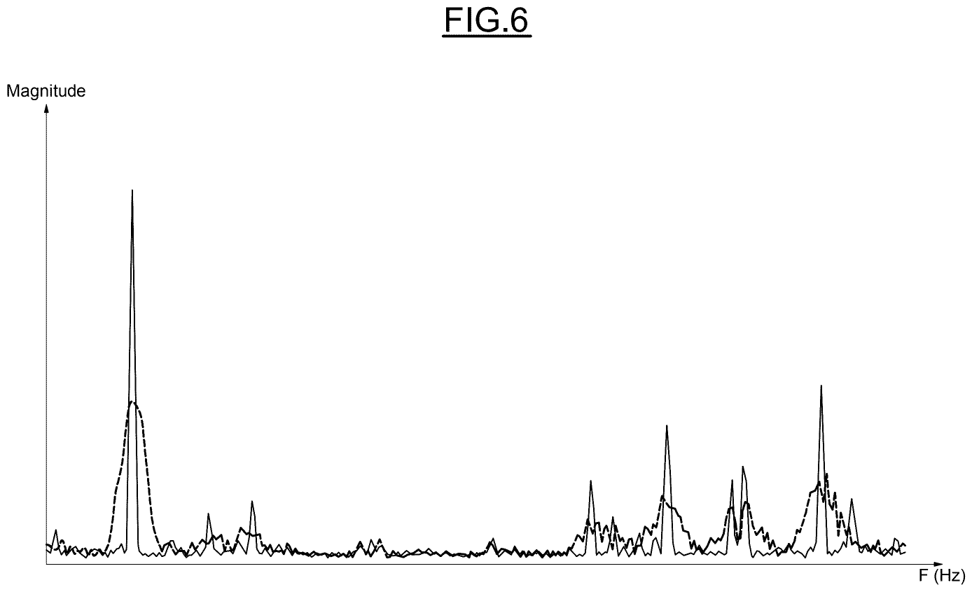

FIG. 6 illustrates an example of the spectrum of vibrations delivered by the sensor 8 without speed compensation (dotted line) and with speed compensation (strong line) wherein the digital signal S9 is resampled by the sampling means 21.

The tones are easily identifiable on the spectrum of vibrations with speed compensation whereas on the spectrum of vibrations without speed compensation, the tones are smeared.

The device 10 allows machine-health assessment for systems and/or sensors which have no means for direct rotational speed measurement.

The device 10 allows to use of any existing algorithm that has been designed for constant speed conditions and are industrially accepted, trusted and well-understood.

The device 10 further obviates repetitive attempts at data acquisition that only must be discarded due to speed changes.

Instead, such data may now be used effectively. The suppression of repetitive attempts at data acquisition permit to save supply power of a system comprising the sensor 8, the sampler 9 and the device 10, for example a wireless system comprising a supply source such as a battery.

What is claimed is:

1. A method for processing a continuous signal sampled at a fixed sample rate to obtain a digital signal, the continuous signal comprising condition monitoring data of a rotating element, the rotating element undergoing rotational speed changes, the method comprising:
(a) segmenting the timestamped samples of the digital signal into a plurality of frames;
(b) transforming each frame of the plurality of frames into the frequency domain and providing arrays comprising absolute values of magnitude and frequency of each transformed frame;
(c) for each transformed frame, determining significant spectral peaks from background noise and their peak center frequencies;
for each pair of frames of a set of frames of the plurality of frames:
(d) determining all feasible frequency ratios of each significant spectral peak of a first frame of the said pair with respect to each significant spectral peak of a second frame of the said pair;
(e) clustering the frequency ratios into clusters of similar frequency ratios;
(f) determining the cluster having the greatest number of frequency ratios and a speed change coefficient from the frequency ratios of the cluster having the greatest number of frequency ratios;
(g) assigning a timestamp value to the speed change coefficient determined at step (f), the timestamp value to the speed change coefficient being determined according to at least one timestamp value of the first or second frame of the said pair;
(h) storing the speed change coefficients and their timestamp values in an array;
(i) generating a speed profile from speed change coefficients and their timestamp values stored in the array; and
(j) resampling the digital signal in the radian domain according to the speed profile.

2. The method according to claim 1, wherein step (i) comprises:
for each timestamp value, selecting a representative speed change coefficient of the speed change coefficients stored in the array;
multiplying each representative speed change coefficient with the average speed of the rotating element to obtain speed values;
obtaining arrays of the representative speed change coefficients depending on their timestamp values; and
applying an interpolation to the selected speed change coefficients to obtain the speed profile.

3. The method according to claim 2, wherein selecting the representative speed change coefficient for each timestamp value comprises:
clustering the speed change coefficients associated to the said timestamp value; and
applying a statistical method to cluster to determine the representative speed change coefficient.

4. The method according to claim 1, further comprising applying a Hanning window to each frame of the plurality of frames prior transforming each frame of the plurality of frames into the frequency domain.

5. The method according to claim 1, further comprising zero padding each frame of the plurality of frames prior transforming each frame of the plurality of frames into the frequency domain.

6. The method according to claim 1, wherein step (d) further comprises cancelling each frequency ratio which is not included in a predetermined interval comprising feasible frequency ratios.

7. The method according to claim 3, further comprising applying a Hanning window to each frame of the plurality of frames prior transforming each frame of the plurality of frames into the frequency domain.

8. The method according to claim 7, further comprising zero padding each frame of the plurality of frames prior transforming each frame of the plurality of frames into the frequency domain.

9. The method according to claim 8, wherein step (d) further comprises cancelling each frequency ratio which is not included in a predetermined interval comprising feasible frequency ratios.

10. A device for processing a continuous signal sampled at a fixed sample rate to obtain a digital signal, the continuous signal comprising condition monitoring data of a rotating element, the rotating element undergoing rotational speed changes, the device comprising:
a segmenting means configured to segment the timestamped samples of the digital signal into a plurality of frames;
a spectral analysis means configured to transform each frame of the plurality of frames into the frequency domain and providing arrays comprising absolute values of magnitude and frequency of each transformed frame;
a filtering means configured to determine significant spectral peaks from background noise and their peak center frequencies for each transformed frame;
a first processing means configured for each pair of frames of a set of frames of the plurality of frames to:
determine all feasible frequency ratios of each significant spectral peak of a first frame of the said pair with respect to each significant spectral peak of a second frame of the said pair;
cluster the frequency ratios into clusters of similar frequency ratios;
determine the cluster having the greatest number of frequency ratios and a speed change coefficient from the frequency ratios of the cluster having the greatest number of frequency ratios; and
assign a timestamp value to the speed change coefficient, the timestamp value to the speed change coefficient being determined according to at least one timestamp value of the first or second frame of the said pair;
a memory configured to store the speed change coefficients and their timestamp values in an array;
a second processing means configured to generate a speed profile from speed change coefficients and their timestamp values stored in the array; and
a sampling means configured to resample the digital signal in the radian domain according to the speed profile.

11. The device according to claim 10, wherein the first processing means is further configured to apply a Hanning window to each frame of the plurality of frames prior transforming each frame of the plurality of frames into the frequency domain.

12. The device according to claim 10, wherein the first processing means is further configured to zero pad each frame of the plurality of frames prior transforming each frame of the plurality of frames into the frequency domain.

13. The device according to claim 11, wherein the first processing means is further configured to zero pad each frame of the plurality of frames prior transforming each frame of the plurality of frames into the frequency domain.

14. A bearing device comprising:
a bearing provided with an inner ring and with an outer ring capable of rotating concentrically relative to one another;
a sensor configured to measure the vibrations of the said inner or outer ring and configured to deliver a continuous signal;
a sampler configured to sample the continuous signal at a fixed sample rate and configured to deliver the digital signal comprising the sequential samples; and
the device according to claim 13 configured to process the digital signal.

15. A bearing device comprising:
a bearing provided with an inner ring and with an outer ring capable of rotating concentrically relative to one another;
a sensor configured to measure the vibrations of the said inner or outer ring and configured to deliver a continuous signal;
a sampler configured to sample the continuous signal at a fixed sample rate and configured to deliver the digital signal comprising the sequential samples; and
the device according to claim 10 configured to process the digital signal.
